(19) United States
(12) Patent Application Publication
(10) Pub. No.: US 2011/0239913 A1
(43) Pub. Date: Oct. 6, 2011

(54) QUICK-ADJUST LEG FOR BENCH-TOP PRODUCTS

(75) Inventors: Brian H. Chung, Arlington Heights, IL (US); Robert S. Doumani, Hoffman Estates, IL (US)

(73) Assignees: ROBERT BOSCH TOOL CORPORATION, Broadview, IL (US); ROBERT BOSCH GMBH, Stuttgart (DE)

(21) Appl. No.: 12/750,290

(22) Filed: Mar. 30, 2010

(51) Int. Cl. A47B 9/00; F16M 11/24

(52) U.S. Cl. 108/146; 108/144.11; 248/188.4; 248/188.2

(57) ABSTRACT

A work bench. The work bench includes a table top, a plurality of legs connected to the table top, and a leg length adjustment mechanism positioned on at least one of the plurality of legs. The leg length adjustment mechanism includes a threaded rod configured to rotate about a rod axis, and a leg adjustment member moveable between a first position where the leg adjustment member threadedly engages the threaded rod and a second position where the leg adjustment member is removed from the threaded rod. Rotation of the threaded rod about the rod axis results in axial movement of the threaded rod when the leg adjustment member is in the first position. The threaded rod is freely moveable along the rod axis when the leg adjustment member is in the second position.

### FIELD

This invention relates to work benches and particularly to height and level control mechanisms for work benches.

### BACKGROUND

Work benches are used for a variety of different applications, such as a platform to hold a power tool, e.g., a power saw. A work bench may be placed on an uneven or unlevel surface. For example, the work bench may be placed on a concrete floor that has a slight to moderate slope in addition to being uneven. Such a floor can cause a top surface of a standard work bench to be unlevel and may allow the work bench to rock on the uneven floor. Both rocking and unlevelness can result in poor quality on the job site in addition to substantial safety issues. For example, if a circular saw is mounted to the top surface of the work bench, and the work bench is placed on a sloped uneven surface, the sloped surface of the work bench can reduce cutting quality of the circular saw.

While work benches are available with legs that offer small height adjustments, for example by way of leveling screws coupled to the bottom of the work bench legs, these work benches are not suitable for floor surfaces that are substantially uneven. In addition, these work benches are sometimes inconvenient to level. Furthermore, in situations where there are steps or severe slopes and the work bench spans over the steps or over the severe slope, a work bench equipped with small height adjustment capabilities is not suitable.

### SUMMARY

According to one embodiment of the present disclosure, there is provided a work bench. The work bench includes a table top, a plurality of legs connected to the table top, and a leg length adjustment mechanism positioned on at least one of the plurality of legs. The leg length adjustment mechanism includes a threaded rod configured to rotate about a rod axis. The leg adjustment member is moveable between a first position where the leg adjustment member threadedly engages the threaded rod and a second position where the leg adjustment member is removed from the threaded rod. Rotation of the threaded rod about the rod axis results in axial movement of the threaded rod when the leg adjustment member is in the first position. The threaded rod is freely moveable along the rod axis when the leg adjustment member is in the second position.

According to another embodiment of the present disclosure, there is provided an adjustable table leg. The adjustable table leg includes a proximal leg portion defining a bore segment extending axially therewith, a threaded rod extending into the bore segment, a coarse adjustment mechanism, and a fine adjustment assembly. The coarse adjustment mechanism is connected to the proximal leg portion. The coarse adjustment mechanism includes a body with a passage through which the threaded rod extends, and a stop member moveable between a release position and a lock position. The stop member is spaced apart from the threaded rod in the release position and is in contact with the threaded rod in the lock position. The fine adjustment assembly includes a distal leg portion and a knob which is rotatable to selectively move the distal leg portion axially in relation to the proximal leg portion.

According to yet another embodiment of the present disclosure, there is provided a height adjustment apparatus for a table leg. The height adjustment apparatus includes a housing defining a central bore therein and fixedly coupled to a leg portion, a rod extending through the central bore of the housing, and a lever pivotable about a pivot moveable from a first position to a second position. The lever is in an interlocked interface with the rod when the lever is in the first position. The lever is released from the rod when the lever is in the second position. When the lever is in the first position the lever is configured to provide an angular orientation relative to the rod that generates a torque about the pivot, the torque generates a force that is applied by the lever to the rod in the interlocked interface, the force has a magnitude that corresponds to the weight applied to the leg portion.

### BRIEF DESCRIPTION OF THE DRAWINGS

FIG. 1 depicts a work bench equipped with a height adjustment assembly coupled to a leg;

FIG. 2 depicts a perspective view of the height adjustment assembly depicted in FIG. 1 with a cut out to reveal a structure for interfacing with the leg of the work bench;

FIG. 3 depicts a cross sectional view of a course height adjustment portion of the height adjustment assembly shown in FIG. 2, depicted in a lock position;

FIG. 3A depicts a fragmentary cross sectional view of the course height adjustment portion of FIG. 3, depicted in a release position; and

FIG. 4 depicts a work bench equipped with two height adjustment assemblies coupled to two legs.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one of ordinary skill in the art to which this invention pertains.

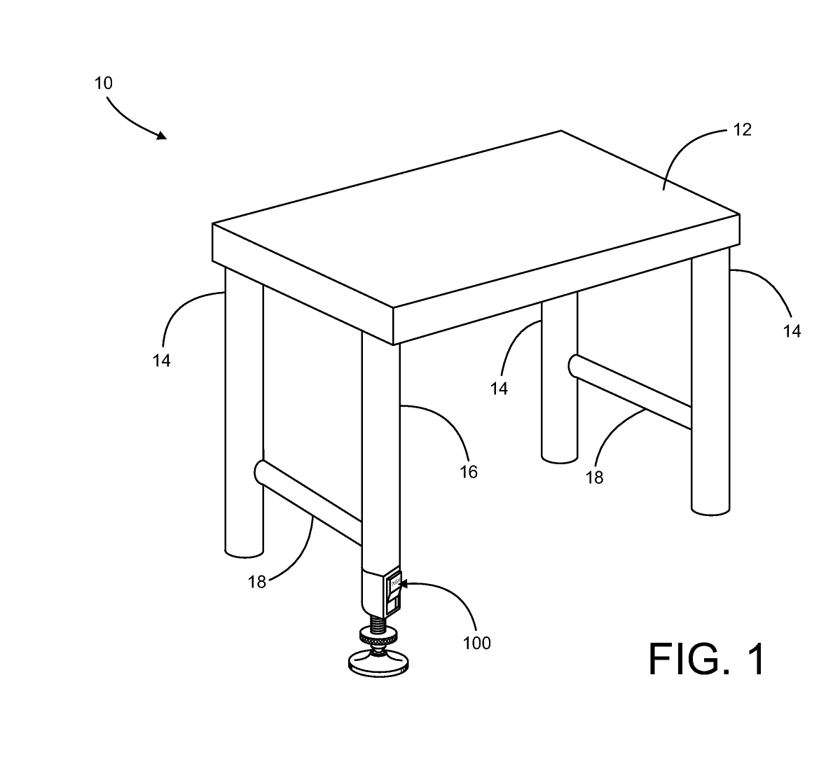

FIG. 1 depicts a perspective view of a work bench 10 equipped with a height adjustment assembly 100. The work bench 10 includes a top surface 12, a plurality of legs 14 which are not equipped with the height adjustment assembly 100, and one leg 16 that is equipped with the height adjustment assembly 100. The work bench is optionally equipped with cross braces 18. The legs 14 and 16 are connected to the top surface by fasteners, not shown.

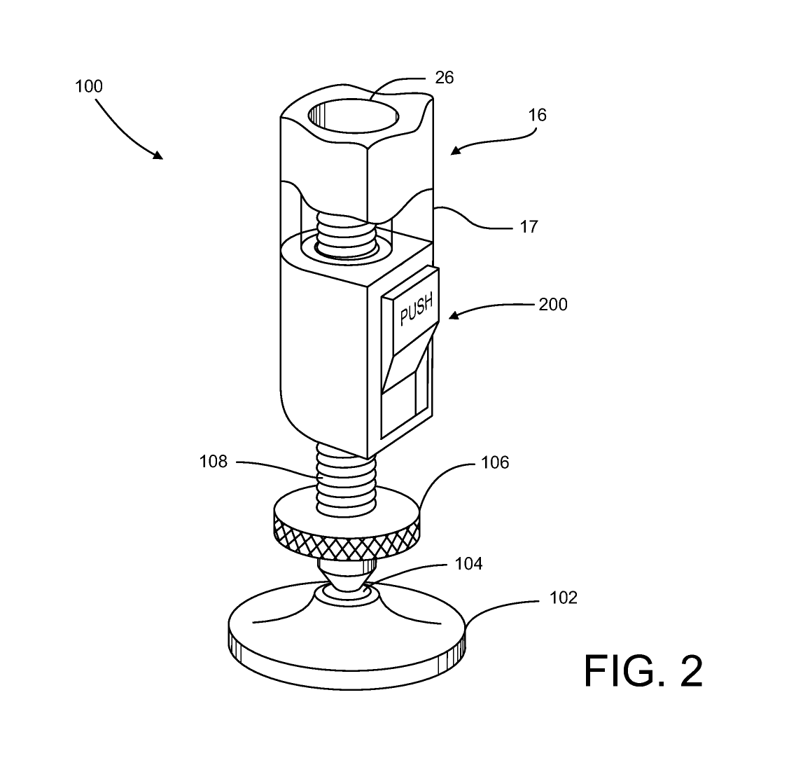

The height adjustment assembly 100 is connected to the end of a leg portion 17 (FIG. 2) or the leg 16 and provides an extension of the leg 16. The height adjustment assembly 100 provides the capability to make coarse and fine height adjustments to the leg 16. As further described below, the height adjustment assembly 100 provides the capability to quickly finding a low spot on a floor surface on which the work bench 10 is resting. Such a low spot can result in the rocking of the work bench 10. With the height adjustment assembly 100 coupled to a leg portion 17 of one leg 16, the work bench 10 can also be automatically leveled, as described below, by activating the height adjustment assembly 100. Auto-leveling of the work bench 10 is possible if the remaining three legs 14 all have the same height and the floor surface under these legs 14 is level. Fine adjustment of the height adjustment assembly 100 is also possible in order to fine tune the levelness of the workbench 10.

FIG. 2 depicts a perspective view of the height adjustment assembly 100. The height adjustment assembly 100 includes a base 102, a swivel member 104, a fine tune dial 106, a height adjustment member 108, and a coarse adjustment assembly 200. The height adjustment assembly 100 is fixedly connected to the leg portion 17 of the leg 16. The interface between the coarse adjustment assembly 200 and the leg portion 17 can be permanent, e.g., by spot welding, or the interface can be provided in a modular manner. A leg extension member (not shown) can be added between the leg portion 17 and the coarse adjustment assembly 200. In other embodiments, the height adjustment assembly 100 may be integrally formed as part of the leg portion 17. A central hole/bore segment 26 in the leg 16 reciprocatingly receives the height adjustment member 108. Therefore, the height adjustment member 108 can move up and down through the central hole 26 within the leg portion 17.

The base member 102 includes a flat bottom surface configured to engage a floor. A cavity is provided in the upper portion of the base member 102 with the swivel member 104 positioned in the cavity. The interface between the base member 102 and the swivel member 104 is in a form of a ball and socket configured to allow free movement of the ball within the socket. Accordingly, the swivel member 104 is free to pivot relative to the base member 102.

The fine tune dial 106 is fixedly coupled to the swivel member 104. In the disclosed embodiment, the fine tune dial 106 is a disc-shaped member with a textured perimeter surface to facilitate gripping of the dial. In one form, the swivel member 104 and the fine tune dial 106 are integrally formed as a single piece. In another form the fine tune dial 106 is connected to the swivel member 104, e.g., by spot welding.

The height adjustment member 108 is fixedly connected to the fine tune dial 106. In the embodiments of FIGS. 1-4, the height adjustment member 108 is provided as a threaded rod. A distal end of the threaded rod is fixedly coupled to the fine tune dial 106. A proximal end of the threaded rod rotatably engages the coarse adjustment assembly 200. In one form, the height adjustment member 108 and the fine tune dial 106 are integrally formed as a single piece. In another form the height adjustment member 108 is connected to the fine tune dial 106, e.g., by spot welding or by using a locking nut (not shown), known in the art. Therefore, in the disclosed embodiments turning the fine tune dial 106 causes rotation of the height adjustment member 108. The height adjustment member 108 may be a hollow or solid rod. The threads on the height adjustment member 108 may extend over the entire length of the height adjustment member or over a smaller portion of the height adjustment member.

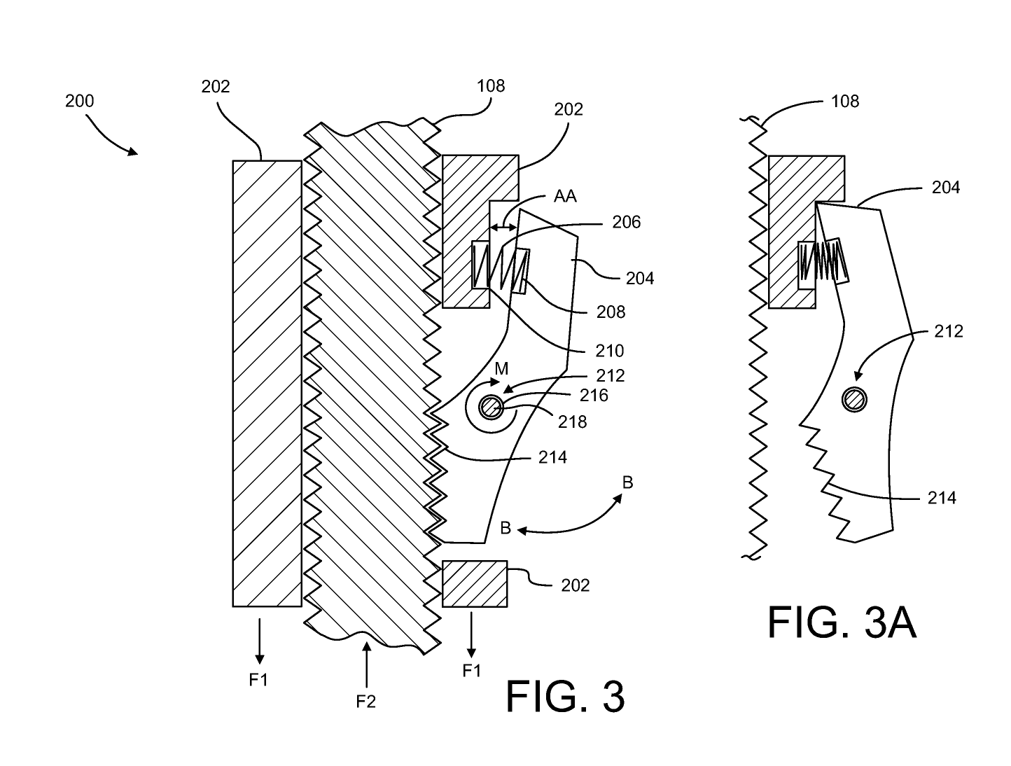

FIG. 3 depicts a cross sectional view of the coarse adjustment assembly 200. The course adjustment assembly 200 includes a body/housing 202, a lever 204, and a spring 206. The housing 202 is fixedly coupled to the leg portion 17. The housing defines a center bore that extends completely through the housing and leads to the central hole 26 in the leg portion 17. The height adjustment member 108 extends through the bore in the housing 202 and into the central hole 26 in the leg portion 17.

A first cavity 210 is formed in the housing 202. The first cavity 210 is designed and dimensioned to receive a first end of the spring 206 such that the spring 206 is retained within the cavity 210.

The lever 204 is pivotably connected to the housing at pivot 212. The pivot 212 includes a hole 216 and a pin 218. The pin 218 passes through the hole 216 and couples with the housing 202 to thereby allow the pivot 212 to pivot about the pin 218, as depicted by a curved double arrow BB in FIG. 3. Therefore, the lever 204 is a stop member pivotable between a lock position, depicted in FIG. 3, and a release position, depicted in FIG. 3A.

A second cavity 208 is formed in the lever 204 near a first end of the lever 204. The second cavity 210 is designed and dimensioned to receive a second end of the spring 206 such that the spring 206 is retained within the cavity 208. The spring 206 biases an upper portion of the lever 204 away from the housing, thus creating a spacing between the housing 202 and the lever 204, as depicted by a double arrow AA in FIG. 3.

The lever 204 includes a toothed or threaded interface 214 at a second end of the lever 204 opposite the first end. The threaded interface 214 is designed and dimensioned to provide an interlocked interface, e.g., a threaded engagement, with the threads on the height adjustment member 108. Several factors including the angular orientation between the lever 204 and the height adjustment member 108, the location of the pivot 212, and the threaded engagement between the threaded interface 214 of the lever 204 and the threads of the height adjustment member 108 create a clockwise torque, indicated in FIG. 3 as M, about the pivot 212.

While the bias force of the spring 206 adds to the clockwise torque M, the main portion of the torque is created by the angular relationship between the lever 204 and the height adjustment member 108. Weights of objects that are placed on the top surface 12 of the work bench 10 as well as the weight of the work bench 10 itself create a downward force which is depicted as F1 in FIG. 3. The force F1 is balanced by an upward force F2 that is exerted to the height adjustment member by the floor. The downward force F1 tends to force the threads of the threaded interface 214 of the lever 204 into closer engagement with the threads of the height adjustment member 108. This downward force F1 also urges the lever 204 to pivot in a clockwise direction, thereby adding to the clockwise torque M. Therefore, a larger force F2, corresponding to a larger force F1, i.e., a heavier weight, creates a larger clockwise torque M.

The relationship between weights of objects placed on the work bench and the clockwise torque M, provides a robust engagement between the threaded interface 214 and the threads on the height adjustment member 108. This relationship reduces the potential for the lever 204 to snap back, which may release the height adjustment member 108.

The work bench 10 is suitable for placing or mounting a power tool, e.g., a ripsaw, on to the top surface 12. In operation, an operator of the work bench 10 can grip the coarse adjustment assembly 200 and while holding the leg/course adjustment assembly 16/200 to overcome the biasing force of the spring 206 in order to close the gap, depicted as the double arrows AA in FIG. 3. The lever 204 pivots about the pivot 212 to disengage the threaded interface 214 from threads of the height adjustment member 108 in an arcuate movement, as depicted in FIG. 3 by the double arrow BB. Once the threaded interface 214 disengages the threads of the height adjustment member 108, the height adjustment member 108 (which is connected to the fine tune dial 106, the swivel member 104, and the base 102) is free to fall by the force of gravity until the base 102 makes contact with the floor. The base 102 swivels relative to the contour and the slope of the floor. The swiveling action of the base 102 increases the contact area between the bottom of the base 102 and the floor.

After the base 102 makes contact with the floor, the operator can then release the lever 204. The lever 204 returns to its resting position by the force of spring 206 by allowing the threaded interface 214 to engage with the threads of the height adjustment member 108.

If the legs 14 are resting on an even and a level floor while the leg 16 is rocking due to an unlevel or uneven floor, the course adjustment assembly 200 can automatically stabilize and level the table when the operator presses the lever 204. The operator can then make fine tune adjustments by rotating the fine tune dial 106. As discussed above, the height adjustment member 108 is connected to the fine tune dial 106. Therefore, rotating the fine tune dial 106 rotates the height adjustment member 108. Also, since the threaded interface 214 of the coarse adjustment assembly 200 is engaged with the threads of the height adjustment member 108, rotating the height adjustment member 108 causes the height adjustment member 108 to axially move with respect to the coarse adjustment assembly 200, thereby raising or lowering the leg 16.

While the height adjustment member 108 is described as a threaded rod, and the interface between the lever 204 and the height adjustment member 108 is described as a threaded engagement, the reader should appreciate that the interface can also be another form of an interlocked interface, e.g., a toothed engagement. In this alternative embodiment, a corresponding height adjustment member is a rod with a toothed interface along an exterior surface of the rod, while a lever which is part of a corresponding coarse adjustment assembly defines a toothed interface at one end of the lever, similar to the lever 204. In this embodiment, rotating the height member would not result in advancement of the height adjustment member inside the coarse adjustment assembly. A fine tune assembly may be provided by combining a corresponding fine tune dial with a corresponding swivel member and a base. The fine tune assembly may have a threaded interface with the height adjustment member at a distal end of the height adjustment member, where rotating the fine tune dial would result in axial movement of the fine tune assembly with respect to the height adjustment member.

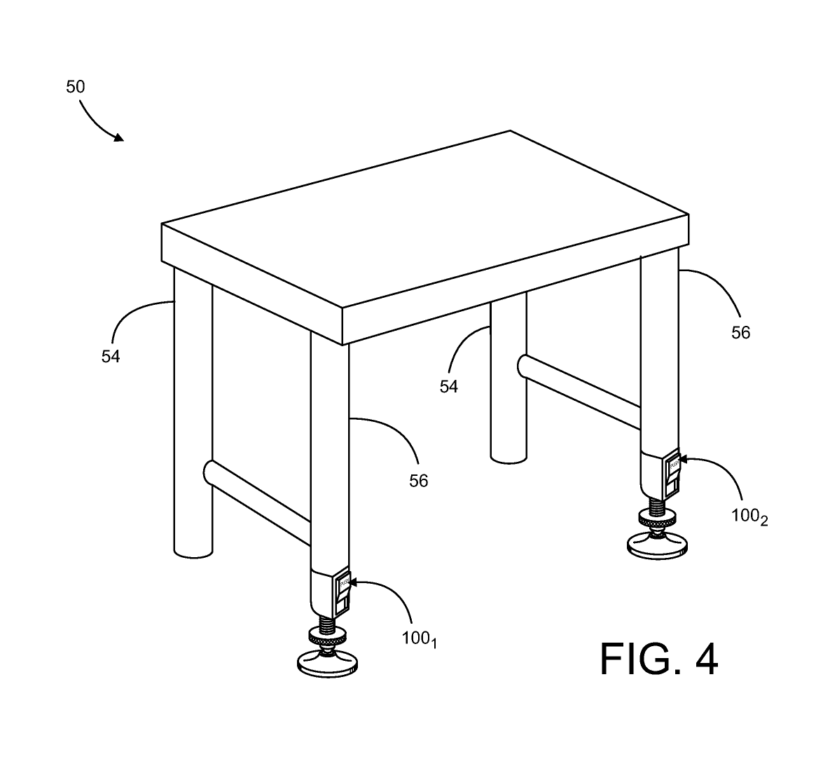

It will be recognized that more than one height adjustment assembly 100 can be connected to the legs of the work bench 10 of FIG. 1. For example, FIG. 4 depicts a work bench 50 with two height adjustment assemblies 100₁ and 100₂. Each height adjustment assembly 100₁ and 100₂ connects to a corresponding leg 56, while two legs 54 are unequipped with a height adjustment assembly. By adjusting the height adjustment assemblies 100₁ and 100₂, the work bench 50 can be configured to interface with steps or with a floor that has a substantial slope.

Also, while FIG. 4 depicts two height adjustment assemblies 100₁ and 100₂ connected to two legs 16 that are on the same side of the work bench 50, it is appreciated that the height adjustment assemblies 100₁ and 100₂ can be connected to legs that are diagonally across from each other. This alternative embodiment may be more suitable for placement of the work bench 50 over a floor that is grossly uneven.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A work bench comprising:
a table top;
a plurality of legs connected to the table top; and
a leg length adjustment mechanism positioned on at least one of the plurality of legs, the leg length adjustment mechanism including,
a threaded rod configured to rotate about a rod axis; and
a leg adjustment member moveable between a first position where the leg adjustment member threadedly engages the threaded rod and a second position where the leg adjustment member is removed from the threaded rod, wherein rotation of the threaded rod about the rod axis results in axial movement of the threaded rod when the leg adjustment member is in the first position, and wherein the threaded rod is freely moveable along the rod axis when the leg adjustment member is in the second position.

2. The work bench of claim 1 wherein the leg adjustment member is provided as a pivotable lever.

3. The work bench of claim 3 wherein the pivotable lever is spring biased toward the first position and the leg adjustment member includes teeth for the threaded engagement with the threaded rod at an interlock interface.

4. The work bench of claim 4 wherein the pivotable lever is retained by a housing connected to a distal end of the one of the plurality of legs.

5. The work bench of claim 1 further comprising a knob connected to the threaded rod such that rotation of the knob results in rotation of the threaded rod.

6. The work bench of claim 1 further comprising a base member that is pivotably connected to the threaded rod, the base member providing a foot for the one of the plurality of legs.

7. The work bench of claim 6 wherein the base member is connected to the threaded rod by a ball and socket arrangement.

8. The work bench of claim 1 wherein at least two of the plurality of legs do not include the leg length adjustment mechanism.

9. The work bench of claim 3 wherein the pivotable lever is configured to pivot about a pivot in an orientation that generates a torque about the pivot, the torque generates a force that is applied by the pivotable lever to the threaded rod, the force has a magnitude that corresponds to the weight that is placed on the at least one of the plurality of legs.

10. An adjustable table leg comprising:
a proximal leg portion defining a bore segment extending axially therewith;
a threaded rod extending into the bore segment;
a coarse adjustment mechanism connected to the proximal leg portion, the coarse adjustment mechanism having a body with a passage through which the threaded rod extends and a stop member moveable between a release position and a lock position, wherein the stop member is spaced apart from the threaded rod in the release position and is in contact with the threaded rod in the lock position; and
a fine adjustment assembly having a distal leg portion and a knob which is rotatable to selectively move the distal leg portion axially in relation to the proximal leg portion.

11. The adjustable table leg of claim 10 wherein the stop member is provided as a pivotable lever.

12. The adjustable table leg of claim 11 wherein the pivotable lever is spring biased toward the release position.

13. The adjustable table leg of claim 12 wherein the pivotable lever is retained by a housing connected to the proximal leg portion.

14. The adjustable table leg of claim 12 wherein the pivotable lever is configured to pivot about a pivot in an orientation that generates a torque about the pivot, the torque generates a force that is applied by the pivotable lever to the threaded rod, the force has a magnitude that corresponds to the weight applied to the proximal leg portion.

15. The adjustable table leg of claim 10, the distal leg portion further comprises a base member that is pivotably connected to the threaded rod, the base member providing a foot for the distal leg portion.

16. A height adjustment apparatus for a table leg comprising:
a housing defining a central bore therein and fixedly coupled to a leg portion;
a rod extending through the central bore of the housing; and
a lever pivotable about a pivot such that the lever is moveable from a first position to a second position, the lever in an interlocked interface with the rod when the lever is in the first position, and the lever released from the rod when the lever is in the second position,
wherein when the lever is in the first position a torque is generated about the pivot, wherein the torque generates a force that is applied by the lever to the rod at the interlocked interface, wherein the force has a magnitude that corresponds to the weight applied to the leg portion.

17. The height adjustment apparatus of claim 16 wherein the lever is spring biased toward the first position.

18. The height adjustment apparatus of claim 16 further comprising:
a base member that is pivotably connected to the rod, the base member providing a foot for the height adjustment apparatus; and
a fine tune adjustment member coupled to the base member configured to threadedly engage the rod at a distal end of the rod.

19. The height adjustment apparatus of claim 18 wherein the base member is connected to the rod by a ball and socket arrangement.

20. The height adjustment apparatus of claim 18 wherein the interlocked interface is one of a threaded engagement, and a toothed engagement.
